(19) United States
(12) Patent Application Publication
(10) Pub. No.: US 2003/0203101 A1
(43) Pub. Date: Oct. 30, 2003

(54) Process for forming a patterned thin film conductive structure on a substrate

(75) Inventors: Jeanne E. Haubrich, San Jose, CA (US); Y. S. Chaug, Los Altos, CA (US); Zarng-Arh George Wu, San Jose, CA (US); Abbas Hosseini, Mountian View, CA (US); Paul Gendler, San Jose, CA (US); Rong-Chang Liang, Cupertino, CA (US)

Correspondence Address: VAN PELT & YI LLP, 10050 N. FOOTHILL BLVD #200, CUPERTINO, CA, 95014, US

(73) Assignee: SiPix Imaging, Inc.

(21) Appl. No.: 10/422,557

(22) Filed: Apr. 23, 2003

Related U.S. Application Data
(60) Provisional application No. 60/375,902, filed on Apr. 24, 2002.

(51) Int. Cl. B05D 5/12; C25D 5/02

(52) U.S. Cl. 427/96; 427/250; 427/261; 427/98; 427/99; 205/118

(57) ABSTRACT

A process for forming a patterned conductive structure on a substrate is disclosed. A pattern is printed with a material, such as a masking coating or an ink, on the substrate, the pattern being such that, in one embodiment, the desired conductive structures will be formed in the areas where the printed material is not present, i.e., a negative image of conductive structure to be formed is printed. In another embodiment, the pattern is printed with a material that is difficult to strip from the substrate, and the desired conductive structures will be formed in the areas where the printed material is present, i.e., a positive image of the conductive structure is printed. The conductive material is deposited on the patterned substrate, and the undesired area is stripped, leaving behind the patterned electrode structures.

### CROSS-REFERENCE TO RELATED APPLICATION

This application claims the benefit of U.S. Provisional Application Serial No. 60/375,902, filed Apr. 24, 2002, the content of which is incorporated herein by reference in its entirety.

### BACKGROUND OF THE INVENTION

1. Field of the Invention

The present invention relates generally to displays. A process for forming a patterned thin film conductor on a substrate is disclosed.

A plastic display, such as an electrophoretic display, typically comprises two electrodes, at least one of which is patterned, and a display medium layer. Biasing voltages typically are applied selectively to the electrodes to control the state of the portion(s) of the display medium associated with the electrodes being biased. For example, a typical passive matrix electrophoretic display may comprise an array of electrophoretic cells arranged in rows and columns and sandwiched between a top and bottom electrode layer. The top electrode layer may comprise, for example, a series of transparent column electrodes positioned over the columns of electrophoretic cells and the bottom electrode layer may comprise a series of row electrodes positioned beneath the rows of electrophoretic cells. Several types of passive matrix electrophoretic displays are described in U.S. Provisional Patent Application Serial No. 60/322,635 entitled “An Improved Electrophoretic Display with Gating Electrodes,” filed Sep. 12, 2001, U.S. Provisional Patent Application Serial No. 60/313,146 entitled “An Improved Electrophoretic Display with Dual mode Switching,” filed on Jul. 17, 2001, and U.S. Provisional Patent Application Serial No. 60/306,312 entitled “An Improved Electrophoretic Display with In-Plane Switching,” filed on Aug. 17, 2001, all of which are hereby incorporated by reference for all purposes.

One typical prior art approach to fabricating the patterned electrode layer(s) for such a plastic display typically involves the use of photolithographic techniques and chemical etching. Conductor films useful for plastic display applications may be formed by a process such as laminating, electroplating, sputtering, vacuum deposition, or combinations of more than one process for forming a conductor film onto a plastic substrate. Useful thin film conductors include metal conductors such as, for example, aluminum, copper, zinc, tin, molybdenum, nickel, chromium, silver, gold, iron, indium, thallium, titanium, tantalum, tungsten, rhodium, palladium, platinum and/or cobalt, etc., and metal oxide conductors such as indium tin oxide (ITO) and indium zinc oxide (IZO), as well as alloys or multilayer composite films derived from the aforementioned metals and/or metal oxides. Further, the thin film structures described herein may comprise either a single layer thin film or a multilayer thin film. ITO films are of particularly interest in many applications because of their high degree of transmission in the visible light region. Useful plastic substrates include epoxy resins, polyimide, polysulfone, polyarylether, polycarbonate (PC), polyethylene terephthalate (PET), polyethylene terenaphthalate (PEN), poly(cyclic olefin), and their composites. The conductor-on-plastics films are typically patterned by a photolithographic process which comprises several time consuming and high cost steps including (1) coating the conductor film with photoresist; (2) patterning the photoresist by image-wise exposing it through a photomask to, for example, ultraviolet light; (3) “developing” the patterned image by removing the photoresist from either the exposed or the unexposed areas, depending on the type of photoresist used, to uncover the conductor film in areas from which it is to be removed (i.e., areas where no electrode or other conductive structures is to be located); (4) using a chemical etching process to remove the conductor film from the areas from which the photoresist has been removed; and (5) stripping the remaining photoresist to uncover the electrodes and/or other patterned conductive structures.

For mass fabrication of a plastic display, such as an electrophoretic display, it may be advantageous to employ a continuous roll-to-roll process. However, the photolithographic approach described above is not well suited to such a roll-to-roll process, as certain of the processing steps, such as the image-wise exposure, are time consuming and require careful registration and alignment of the mask and the moving target area. In addition, development and stripping of photoresist and treatment of waste from the chemical etching process may be time consuming and expensive, in addition to potentially posing an environmental hazard.

Therefore, there is a need for a process for forming patterned conductive structures on a plastic substrate, for use in a plastic display such as an electrophoretic display, that does not require the use of photolithography or chemical etching and that is suitable for use in a continuous roll-to-roll process.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a flowchart illustrating a process used in one embodiment to form a patterned thin film conductor on a substrate.

FIGS. 2A through 2D illustrate a schematic plan view of a series of processing steps used to form four column electrodes on a substrate.

FIGS. 3A through 3D further illustrate the example shown in FIGS. 2A through 2D by providing a schematic front cross-sectional view of the processing steps shown in FIGS. 2A through 2D.

FIGS. 4A and 4B illustrate a schematic plan view of an example in which segment electrodes for a seven segment display are formed using an embodiment of the process described herein.

FIGS. 5A-1 through 5D-2 illustrate an alternative process used in one embodiment to form a patterned thin film conductor on a substrate.

FIGS. 6A-1 through 6F-2 illustrate a further alternative to the process shown in FIGS. 1-4.

### DETAILED DESCRIPTION

A detailed description of a preferred embodiment of the invention is provided below. While the invention is described in conjunction with that preferred embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

A process for forming a patterned conductive structure on a substrate is disclosed. A pattern is printed with a material, such as a masking coating or an ink, on the substrate, the pattern being such that, in one embodiment, the desired conductive structures will be formed in the areas where the printed material is not present, i.e., a negative image of conductive structure to be formed is printed. In another embodiment, the pattern is printed with a material that is difficult to strip from the substrate, and the desired conductive structures will be formed in the areas where the printed material is present, i.e., a positive image of the conductive structure is printed. The conductive material is deposited on the patterned substrate, and the undesired area is stripped, leaving behind the patterned electrode structures.

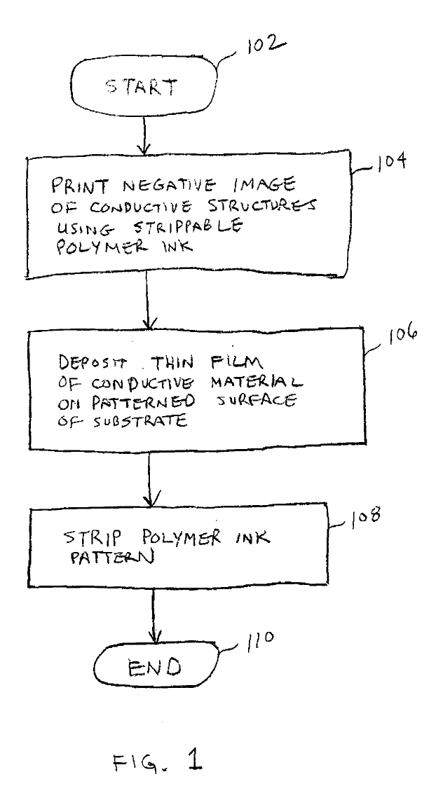

FIG. 1 is a flowchart illustrating a process used in one embodiment to form a patterned thin film conductor on a substrate. The process begins in step 102 and proceeds to step 104 in which a negative image of the conductive thin film structures to be formed is printed on the surface of the substrate using a masking coating or ink. In one embodiment, the masking coating or ink may be stripped using an aqueous solution and/or another common solvent. In step 104, a negative image of the conductive structures to be formed is printed in the sense that the masking coating or ink will cover areas of the substrate where the conductive material will not be present upon completion of the process and will not cover areas of the substrate where the conductive material will be present. In essence, the ink pattern serves as a mask for the subsequent deposition of conductive material, as described more fully below in connection with step 106.

Any suitable printing techniques, such as flexographic, driographic, electrophotographic, and lithographic printing, may be used to print the ink pattern on the substrate. In certain applications, other printing techniques, such as screen printing, gravure printing, ink jet, and thermal printing may be suitable, depending on the resolution required. In addition, the masking coating or ink does not need to be optically contrasted with the substrate, and can be colorless.

In step 106, a thin film of conductive material is deposited on the patterned surface of the substrate. In one embodiment, vapor deposition is used to deposit the thin film of conductive material on the patterned side of the substrate in step 106. In such an embodiment, aluminum, copper, or any conductive material suitable for being deposited as a thin film through vapor deposition or spraying may be used as the conductive material. In one alternative embodiment, the conductive material is deposited by sputter coating the patterned side of the substrate with the conductive material. In such an embodiment, indium tin oxide (ITO) or any other conductive material such as gold, silver, copper, iron, nickel, zinc, indium, chromium, aluminum-doped zinc oxide, gadolinium indium oxide, tin oxide, or fluorine-doped indium oxide, or any other conductive material suitable for being deposited in a thin film through sputter coating may be used.

In step 108 of the process shown in FIG. 1, the masking coating or ink is stripped from the patterned surface of the substrate on which the conductive material has been deposited in step 106. The stripping of the coating/ink in step 108 has the effect of stripping away the printed pattern formed in step 104 as well as the portion of the conductive material deposited in step 106 that was deposited on to the areas of the substrate where the coating/ink was present. As a result, the stripping solvent is able to strip away the coating/ink pattern and the conductive material formed on the top surface of the coating/ink pattern, even though the stripping step is performed after the deposition of the conductive thin film in step 106. The process shown in FIG. 1 then ends in step 110. Without limiting the generality of the present disclosure, it is believed that in certain embodiments at least part of the masking coating/ink printed in step 104 is exposed, or nearly so, to the stripping solvent, despite the masking patterns having been covered with metal thin film as a result of the deposition process of step 106. In one embodiment, low molecular weight additives such as plasticizers, surfactants, and residual monomers or solvents in the masking coating/ink may cause defects or microporosity in the metal coated on the ink, accelerating exposure of the masking coating to the solvent. The present disclosure contemplates that any suitable combination of coating/ink, metal thin film, and stripping process may be used, without limiting the applicability of the present disclosure in any way, and without limiting the present disclosure to any particular stripping mechanism or theory. With respect to the process shown in FIG. 1, the only requirement is that the combination used be such that upon stripping the areas of conductive film formed on the substrate remain present and the areas of conductive thin film formed on the strippable masking coating/ink be stripped away, or largely so, such that the areas where the coating/ink pattern was present are not conductive, or sufficiently nearly so for the display to operate properly.

The process described above does not require the use of photolithography and selective etching of the conductive layer to define patterned conductive structures on a substrate. Instead, the ink pattern is used to define, prior to the deposition of the conductive material, the shape of the conductive structures to be formed. Because a simple solvent, such as water, aqueous solutions, alcohols, ketones, esters, DMSO, or many other common organic solvents or solvent mixture, may be used to strip away the ink and the conductive material formed on top of the ink pattern, the patterned conductive structures may be formed via a roll-to-roll process that is not as time consuming, not as expensive, and does not generate as much toxic chemical waste as the photolithographic and chemical etching techniques used in prior art photolithographic processes.

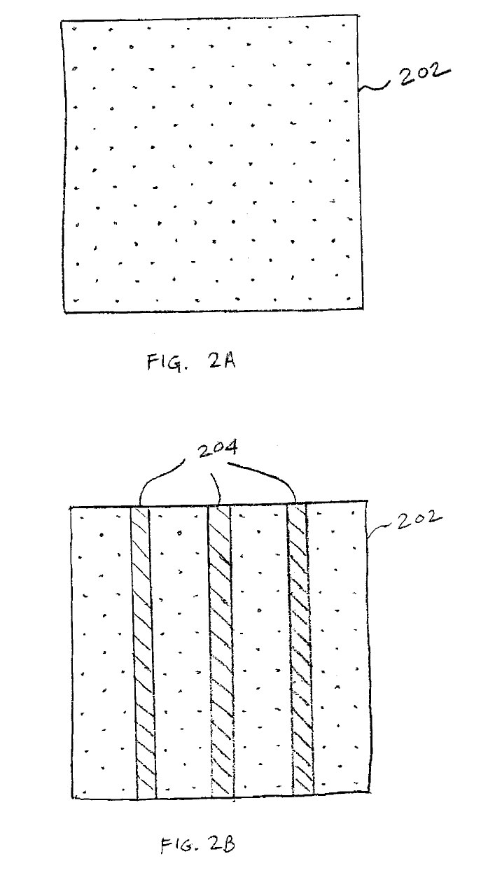

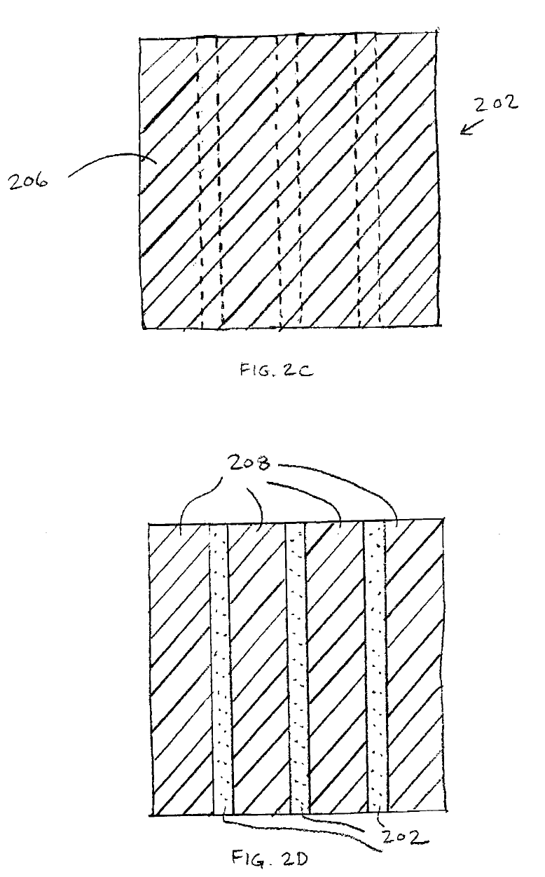

As noted above, one type of display that the above-described process may be used in connection with is a passive matrix display, such as a passive matrix electrophoretic display. A passive matrix display may, for example, comprise a patterned electrode layer comprising a plurality of column or row electrodes. FIGS. 2A through 2D illustrate a schematic plan view of a series of processing steps used to form four column electrodes on a substrate. FIG. 2A shows a plastic substrate 202. In FIG. 2B an ink pattern comprising lines 204 has been printed on the substrate 202. In the example shown in FIG. 2B the lines 204 define on the substrate 202 areas on which four column electrodes will be formed, as described more fully below, in the areas of substrate 202 that are not covered by the lines 204.

In FIG. 2C, a conductive thin film layer 206 has been formed on the patterned surface of the substrate, covering both the portions of the substrate 202 that are not covered by the ink lines 204 (shown by dashed lines in FIG. 2C) and the portions that are covered by the ink lines 204. In FIG. 2D, the ink pattern has been stripped away, along with the portions of the conductive thin film 206 that were deposited on the ink lines 204, exposing column electrodes 208. The respective column electrodes 208 are separated from each other by the areas of the substrate 202 exposed by the stripping away of the ink lines 204.

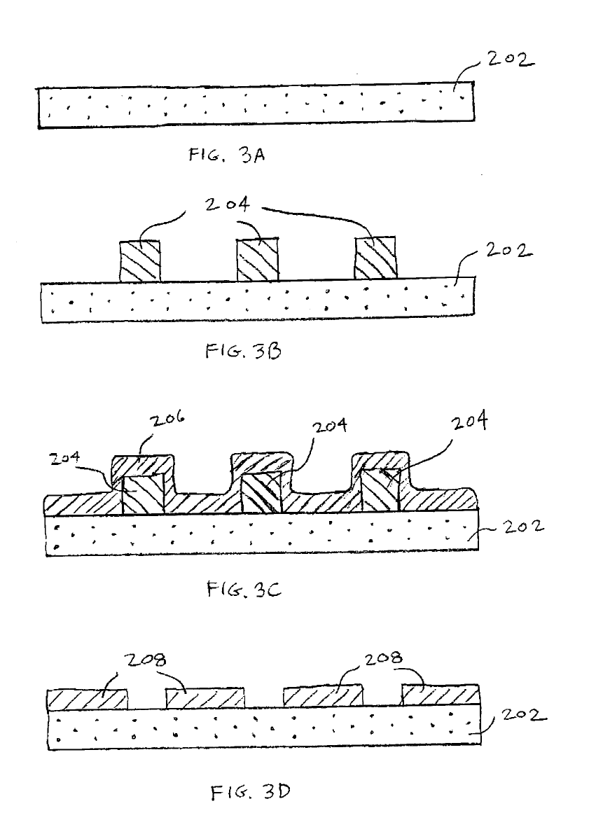

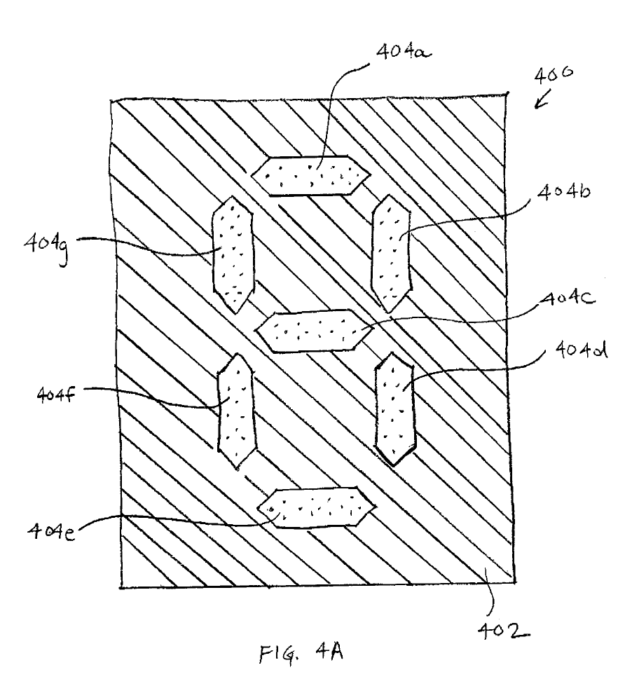

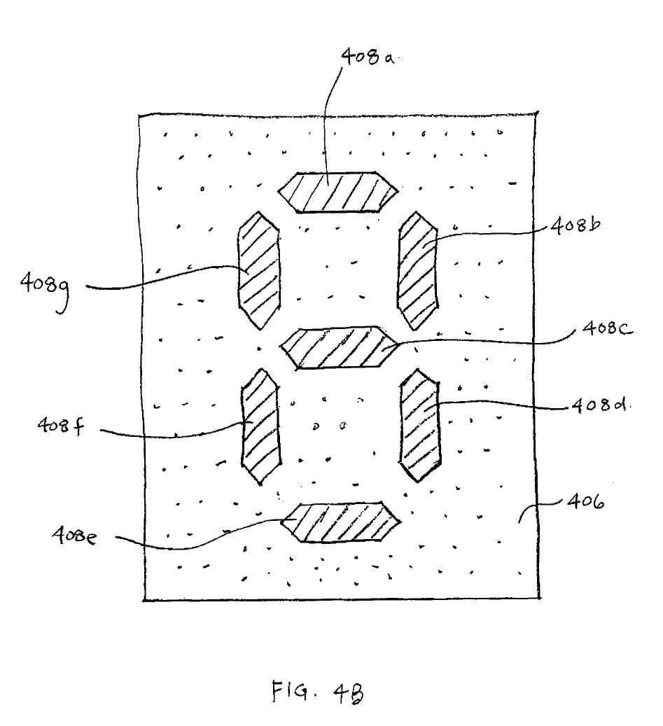

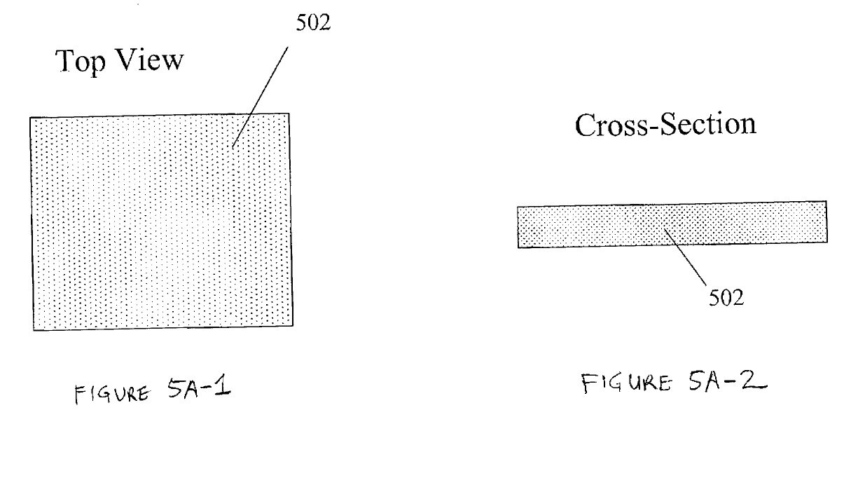

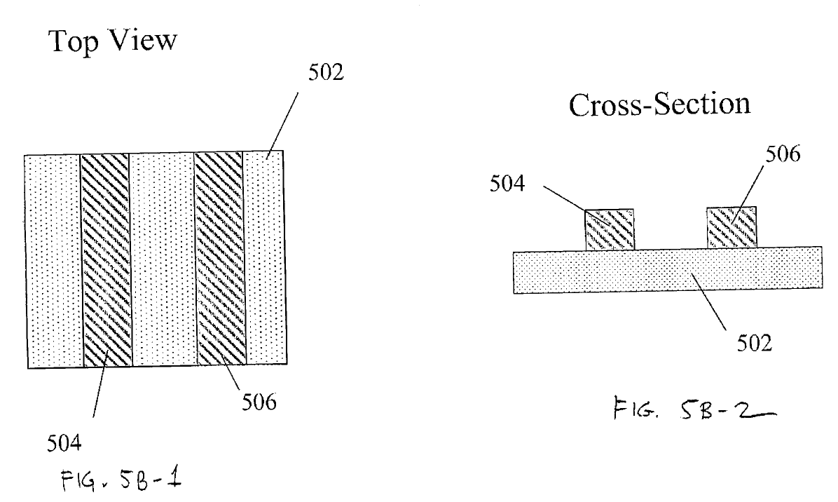

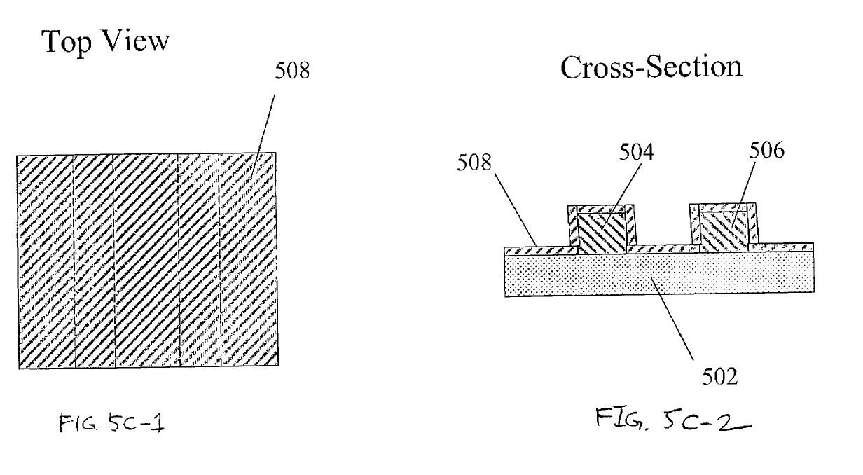

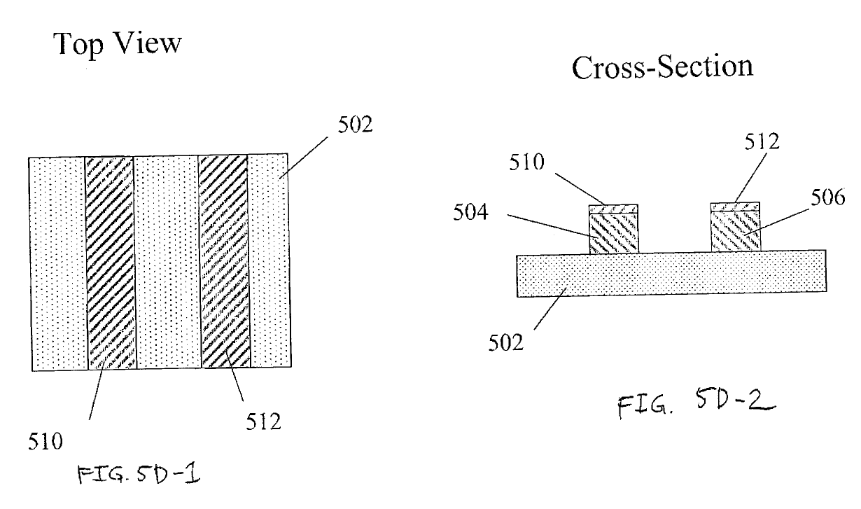

FIGS. 3A through 3D further illustrate the example shown in FIGS. 2A through 2D by providing a schematic front cross-sectional view of the processing steps shown in FIGS. 2A through 2D. FIG. 3A shows a front cross-sectional view of the substrate 202. FIG. 3B shows the ink lines 204 formed on the substrate 202. As shown in FIG. 3C, the conductive layer 206 forms on the portions of the substrate not covered by the lines 204 and on the top and side surfaces of the polymer ink lines 204. Finally, FIG. 3D shows the column electrodes 208 that remain formed on the substrate 202 subsequent to the stripping of the lines 204, which has the effect of stripping away both the ink lines 204 and any conductive material 206 formed on top of the ink lines 204.

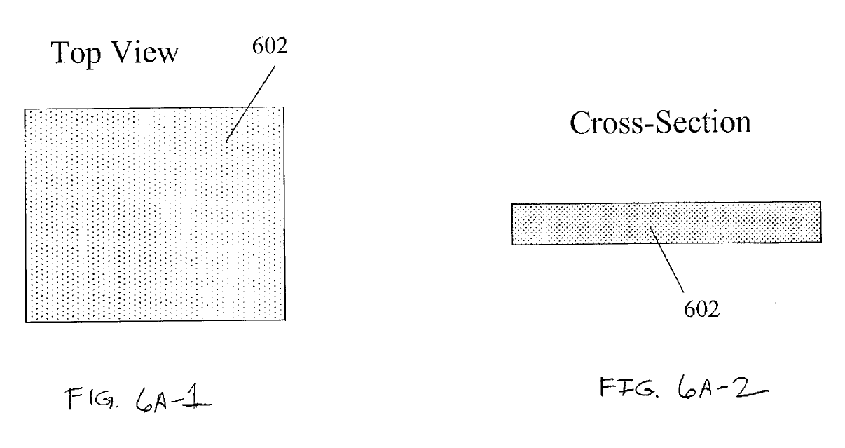

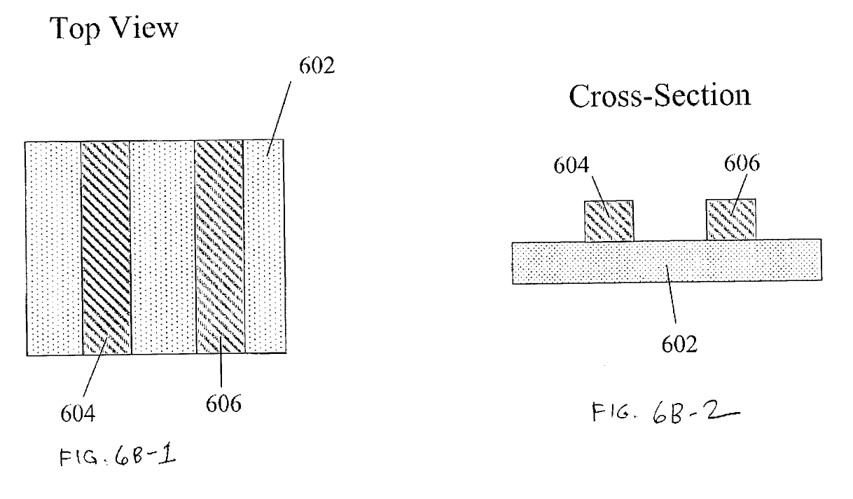

While FIGS. 2A-2D and 3A-3D illustrate an example in which four column electrodes are formed on a plastic substrate, the coating/ink may be printed in any pattern to define on the substrate conductive structures of any desired shape or size. FIGS. 4A and 4B illustrate a schematic plan view of an example in which segment electrodes for a seven segment display are formed using an embodiment of the process described herein. FIG. 4A shows display electrode layer 400 comprising a polymer ink pattern 402 defining on a plastic substrate seven segment electrode areas 404a-404g in which the ink pattern 402 is not present such that the underlying substrate is exposed. FIG. 4B shows the same display electrode layer 400 subsequent to the steps of deposition of the conductive thin film and stripping of the ink pattern. As shown in FIG. 4B, the stripping away of the ink exposes a background area 406 of the substrate on which no conductive structure is present. In addition, segment electrodes 408a-408g have been formed and remain in the segment electrode areas 404A-404G defined as described above in connection with FIG. 4A.

As is apparent from the above discussion, conductive structures of any shape or size may be formed simply by defining through use of the printed pattern areas on the substrate on which conductive structures are to be formed. The structures may include electrode structures such as those described above and/or conductive traces or any other conductive structure desired.

The processes described herein may be used in one embodiment to form a top or bottom electrode layer to be disposed adjacent to an electrophoretic display media layer. In one embodiment, the electrophoretic display media comprises a layer of sealed microcups, each comprising a quantity of electrophoretic dispersion. In one embodiment, a protective overcoat such as an antiglare protective coating comprising particulate filler may be applied onto the sealed microcups or the top (viewing side) electrode layer to further improve the optical or physicomechanical properties of the finished panel.

In one embodiment, conductive structures are formed on both the top and bottom surfaces of the substrate, using the process described herein first to form conductive structures on one side of the substrate and then to form conductive structures on the opposite side of the substrate using the same series of steps described above for forming conductive structures on one side of the substrate. In one embodiment, conductive structures on the top surface of the substrate may be connected electrically to conductive surfaces formed on the bottom surface of the substrate by forming via holes and completing an electrical connection through the via hole from a conductive structure on the top surface of the substrate to a conductive structure on the bottom surface of the substrate, as described in U.S. patent application Ser. No. ______ (Attorney Docket No. 26822-0049), which was previously incorporated herein by reference.

In one embodiment of the process illustrated in FIGS. 1-4, the coating/ink used to pattern the substrate comprises Sun Chemical Aquabond AP blue ink and/or Sunester red ink (Sun Chemical, Northlake, Ill.) and the substrate comprises 5 mil thick Melinex 453 polyester (DuPont Teijin, Hopewell, Va.). The ink may be applied through a stencil using a hand proofer with a #360 anilox roller. The ink may be dried with a heat gun. The metal thin film is deposited by loading the patterned substrate into a DC-magnetron sputtering system to deposit ITO film up to about 100 nm thickness. The patterned substrate may be plasma treated prior to deposition of the metal thin film. The ink pattern and metal thin film formed thereon is stripped by spraying the patterned substrate on which the metal thin film has been formed with acetone (Histological grade, Fisher Scientific) for 1 to 2 minutes at room temperature. The above processing steps result in the metal thin film (i.e., ITO) formed in the ink pattern being removed along with the ink, leaving an area on the substrate where no ITO coating is present such that no measurable conductivity in present in such areas where the ITO has been removed.

In one embodiment of the processes illustrated in FIGS. 1-4, Film III Warm Red ink (Environmental Inks and Coatings, Los Angeles, Calif.) is applied using a hand proofer to define a pattern or mask on a substrate comprising 5 mil thick Melinex ST505 polyester (DuPont Teijin, Hopewell, Va.). The metal thin film is deposited by loading the patterned substrate into a DC-magnetron sputtering system to deposit ITO film up to about 100 nm thickness. The ink is washed from the ITO coated patterned substrate by spraying with acetone (Histological grade, Fisher Scientific) for 30 to 60 sec. The ITO formed on the ink is removed along with the ink, leaving an area where there is no ITO coating where the ink pattern was printed.

In one embodiment of the processes illustrated in FIGS. 1-4, the ink pattern is printed on 5 mil thick, 4507 Polyester (Transilwrap, Franklin Park, Ill.) using GP-217 Process Magenta ink (Ink Systems Inc., Commerce, Calif.) on an offset press. The inked polyester is loaded in a vacuum system for aluminum evaporation at the film thickness of 120 nm. The aluminum coated polyester is immersed in hot (T=about 80° C.) methyl ethyl ketone (Certified grade, Fisher Scientific, MEK) for 15 seconds, and then wiped gently with a cotton swab soaked in MEK. This process strips the inked area from the polyester, along with the aluminum on top of the ink. The stripping results in a negative image from the ink, i.e., there is no aluminum coating in the areas where the ink pattern was printed, with the remaining areas (i.e., where the ink pattern was not present) being coated with aluminum.

In one embodiment of the processes illustrated in FIGS. 1-4, an ink pattern is made on a roll of 5 mil thick, 12″ wide Melinex 453 polyester (Plastics Suppliers, Fullerton Calif.) using Film III Warm Red ink (Environmental Inks and Coatings, Los Angeles, Calif.) on a Mark Andy 4200 flexographic press. The patterned polyester is loaded into a DC-magnetron sputtering system to deposit ITO film for about 100 nm. Prior to the deposition, the ink coated sheets may be plasma treated. The ITO coated polyester is then immersed in a jar of hot (T=about 80° C.) MEK and cleaned ultrasonically using a Fisher Scientific FS220H ultrasonic cleaner for 2 minutes. As a result of the ultrasonic cleaning step, the ink is stripped from the polyester, along with the ITO formed on top of the ink.

In one embodiment in which conductive structures are formed on both the top and bottom surfaces of the substrate, the processes illustrated in FIGS. 1-4 may comprise printing on both sides of a roll of Melinex 561 polyester (10″ wide, 4 mil thick, DuPont Teijin Films, Wilmington, DL) using Film III Warm Red Ink (Environmental Inks and Coatings, Morganton, N.C.) on a Mark Andy 4200 flexographic press. In one embodiment, the first side is printed with a first pattern A at one printing station, the web is run through a turn bar that flips the web, and the other side of the substrate is aligned and printed with a second pattern B at the next plate station during the same printing run. In one embodiment, the first pattern A comprises a negative image defining ink free areas in which segment electrodes are to be formed, and the second pattern B comprises a negative image defining ink free areas in which conductive lines are to be formed. The patterns are aligned such that each ink free segment electrode area in pattern A is aligned with the end of one ink free conductive line in pattern B, such as may be desirable to allow for an electrical connection to be made between a segment electrode of side A and a conductive line of side B through a conductive via structure through the substrate. In one embodiment, about 40′ of the polyester printed on both sides is sputtered on both sides with 2500 angstroms of aluminum. A 5″×5″ piece of the aluminum coated polyester is developed by immersing it in a crystallizing dish containing methyl ethyl ketone, and putting the dish into a Fisher #FS220H ultrasonicator (Fisher Scientific, Pittsburg, Pa.) filled an inch deep with water for 2 minutes. This yields a polyester electrode with one side having aluminum only in the segment pattern of the ink free areas of A, and the opposite side having the electrode pattern of the ink free lines in B.

The ability to strip away the masking coating/ink lines after deposition of the metal thin film using a simple stripping process that is not destructive of the metal thin film formed in the areas where the coating/ink pattern is not present (such as but not limited to the solvent and physical peeling processes described above) facilitates a continuous fabrication process, such as a roll to roll fabrication process, because no time consuming batch processes such as image-wise exposure and development of photoresist, etching away portions of a conductive layer not covered by photoresist, or using solvents requiring special handling or conditions to remove a photoresist layer after etching, are required. By saving time and using less expensive materials, the process described herein is much less costly than other processes typically used to form on a polymer substrate the types of structures described herein.

FIGS. 5A-1 through 5D-2 illustrate an alternative process used in one embodiment to form a patterned thin film conductor on a substrate. The alternative process shown in FIGS. 5A-1 through 5D-2 employs a “positive” printed image in the sense that the coating/ink is printed in the pattern of the conductive thin film structure(s) to be formed, instead of being used as described above in connection with FIGS. 1-4 to define areas where the conductive thin film structure(s) is/are not to be formed. The process illustrated in FIGS. 5A-1 through 5D-2 is similar to that shown in FIGS. 1-4 in that the process shown in FIGS. 5A-1 through 5D-2 employs printing techniques to define the conductive thin film structure(s) to be formed. The process shown in FIGS. 5A-1 through 5D-2 differs from the process shown in FIGS. 1-4, however, in that the printed pattern is not stripped off the substrate, as described more fully below.

As shown in FIGS. 5A-1 and 5A-2, the conductive thin film structures are formed on a substrate 502. The substrate 502 may be any of the substrate materials described above for use in the process illustrated by FIGS. 1-4. In one embodiment, the substrate comprises 5 mil thick, 4507 Polyester (available from Transilwrap, Franklin Park, Ill.). FIGS. 5B-1 and 5B-2 show pattern lines 504 and 506 printed on the substrate 502. In one embodiment, the pattern lines 504 and 506 are printed on the substrate 502 using GP20011 UV Process Magenta ink (Ink Systems Inc., Commerce, Calif.) on an offset press. Any ink or other printable material may be used that has the characteristic that the subsequently deposited metal thin film adheres to the printed material more strongly than it adheres to the substrate, as explained more fully below.

FIGS. 5C-1 and 5C-2 show a metal thin film layer 508 being formed on the patterned surface of the substrate, covering both the printed pattern (lines 504 and 506) and the areas of the substrate 502 not covered by the printed pattern. In one embodiment, the conductive thin film 508 is formed by loading the patterned substrate into a vacuum system for aluminum evaporation at a film thickness of 120 nm.

FIGS. 5D-1 and 5D-2 show the remaining structures after the portions of the conductive thin film 508 formed on the substrate 502 have been removed by a stripping process. Conductive thin film structures 510 and 512 remain formed on printed lines 504 and 506, respectively. In one embodiment, a solvent is used to remove the portions of the conductive thin film formed directly on the substrate, but not the portions of the conductive thin film formed over the printed material, leaving conductive thin film structures in the same pattern as the printed material. In one embodiment, not shown in FIGS. 5D-1 and 5D-2, some or all of the conductive thin film formed on the side surfaces of the printed material remains adhered to the side surfaces of the printed material after the stripping process. In one embodiment, not all of the conductive thin film formed directly on the substrate is removed by the stripping process, but the conductive thin film formed directly on the substrate is removed sufficiently to cause there to be no measurable conductivity in the areas of the substrate where the printed material was not printed.

The alternative process shown in FIGS. 5A-1 through 5D-2 requires that the adhesion of the conductive thin film layer to the substrate be low, the adhesion of the conductive layer to the printed material be high, the adhesion of the printed material to the substrate be high, and that the solvent be such that it removes the portions of the conductive layer that are formed directly on the substrate but not those portions of the conductive layer formed on the printed material.

In another alternative process, a substrate having a poor affinity toward the metal thin film may be used. In one such embodiment, a surface treatment or primer coating such as a UV curable polymer layer, having good adhesion to both the substrate and the metal thin film is used to replace the masking coating/ink in steps 104 and 106 of the process shown in FIG. 1. In this case, the metal thin film on the uncoated areas will be removed in the stripping process to reveal the electrode pattern or trace on the top of the surface treatment or primer coating. This alternative process is similar to that shown in FIGS. 5A-1 through 5D-2, with the primer coating comprising the printed material, such as pattern lines 504 and 506.

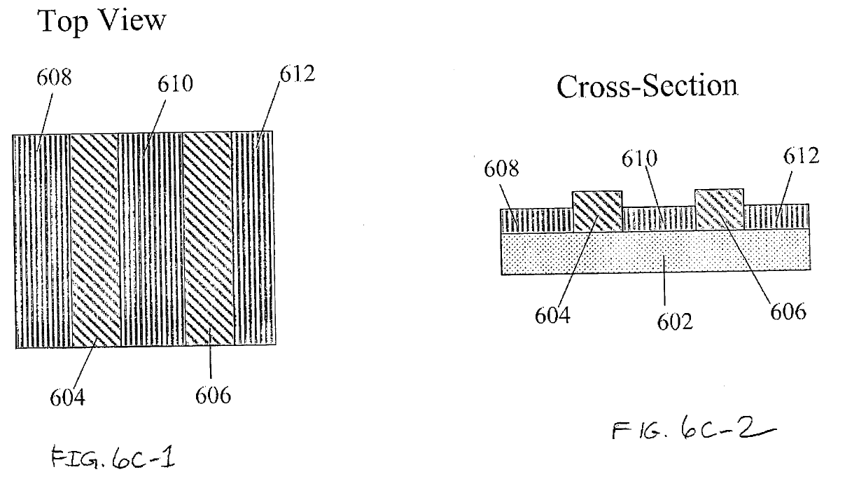

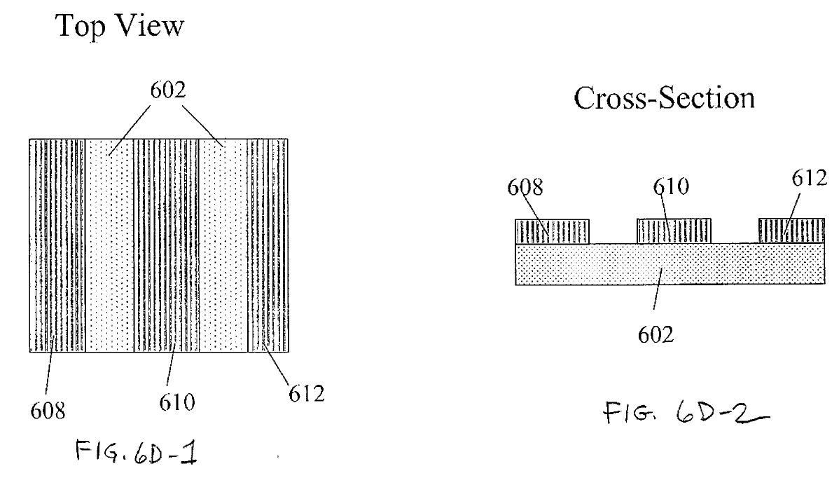

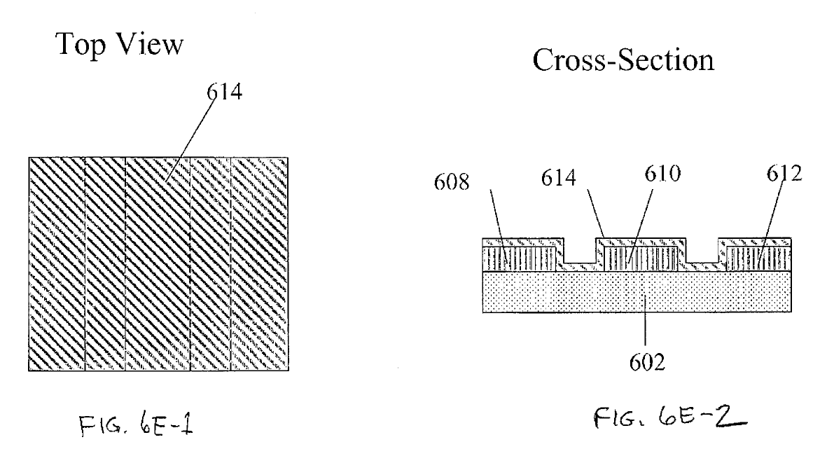

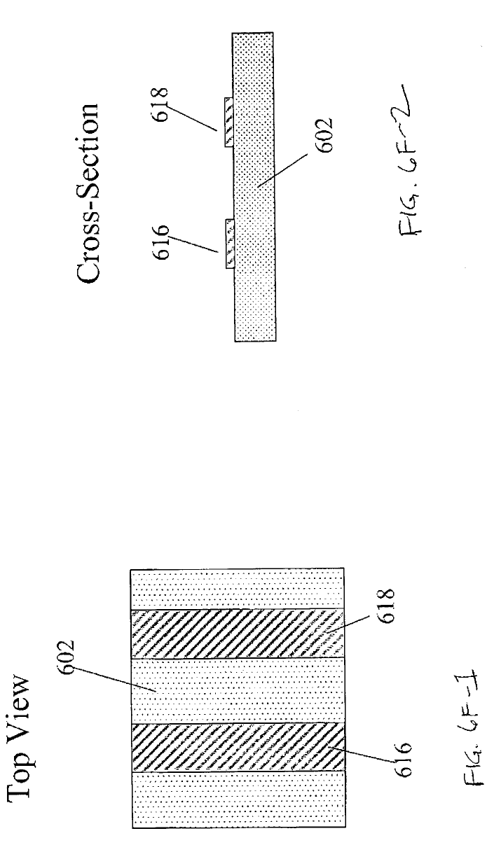

FIGS. 6A-1 through 6F-2 illustrate a further alternative to the process shown in FIGS. 1-4. FIGS. 6A-1 and 6A-2 show a substrate 602. In FIGS. 6B-1 and 6B-2, pattern lines 604 and 606 have been printed onto the substrate 602 using a hydrophobic (i.e., water repelling) and solvent soluble printable first material that has a low surface tension. As shown in FIGS. 6C-1 and 6C-2, the printed substrate is then over-coated with a second, water-based material that is repelled by the first material, such that the overcoat adheres only to those portions of the substrate not covered by the first material, forming areas 608, 610, and 612 comprising the second (water-based) material. Next, the water repelling first material is stripped using a suitable solvent that does not also strip away the second (water-based) material, leaving the structure shown in FIGS. 6D-1 and 6D-2, in which the structures 604 and 606 comprising the first (water repelling) material have been stripped away, leaving the structures 608, 610, and 612 comprising the second (water-based) material on the substrate 602. Next, as shown in FIGS. 6E-1 and 6E-2, a conductive thin film 614 is formed both on the structures 608, 610, and 612 and on the portions of the substrate 602 not covered by the second (water-based) material, using one of the conductive thin film materials described above, by sputtering, vapor deposition, spraying, or some other suitable technique. Finally, FIGS. 6F-1 and 6F-2 show the conductive thin film structures 616 and 618 that remain after the water-based material has been stripped away with an appropriate solvent, or another appropriate chemical or mechanical stripping process.

Under the process shown in FIGS. 6A-1 through 6F-2, the printed pattern of the first (water repelling) material comprises a positive image of the conductive thin film structures to be formed. Once the first (water repelling) material has been stripped away, as described above, the remaining second (water-based) material comprises a negative image of the conductive thin film structures to be formed. In a sense, the first (water repelling) material may be considered a mask that may be used to define areas having very small dimensions, such as very fine lines, in which the conductive thin film structures will not be present. While it may be difficult with practically useful printing techniques, such as flexographic, to print such narrow lines in the first instance, for example because of physical limitations, spreading of the ink after printing, etc., such techniques may be used readily to print less fine lines or less small areas with only small gaps separating the lines or areas. A second (water-based) material, such as a water-based ink, may then be used, as described above, to fill in the narrow spaces between the areas covered by the first (water repelling) material, which first material may then be stripped away using an appropriate solvent, leaving behind very fine lines or other shapes comprising the second material, which very fine lines or shapes it may not have been practical to print in the first instance. These lines may then be used, as described above, as a negative image for the formation of adjacent conductive thin film structures separated by very narrow gaps, for example.

In one embodiment, a physical stripping process such as peeling is used to reveal the electrode pattern. For example, an adhesive tape having an appropriate cohesion strength and adhesion strength to ITO is laminated onto an ITO/PET film pre-printed with a masking coating/ink. A subsequent peeling will remove the ITO either on the area printed with masking ink or on the area without the ink depending on the cohesion strength of the ink and the adhesion strengths at the ink-PET and ITO-PET interfaces. This stripping technique may be used with any of the processes described above.

In one embodiment, the process of FIGS. 6A-1 through 6F-2 comprises printing a positive image of the desired conductive structures on a roll of Melinex 582 polyester (4 mil thick, 14″ wide, Dupont Teijin Films, Wilmington, DL) using Film III Warm Red Ink (Environmental Inks and Coatings, Morganton, N.C.) on a Mark Andy 4200 flexographic press. The printed portion of the polyester roll is then coated with a solution consisting of 16 parts of aqueous 10% polyvinyl pyrrolidinone (PVP-90, ISP Technologies, Inc., Wayne, N.J.), 0.40 parts Sunsperse Violet (Sun Chemical, Cincinnati, Ohio), and 16 parts water using a #6 Meyer bar, and dried 1.5 minutes in an oven at 80° C. The film is then placed in a crystallizing dish containing ethyl acetate. A 10″×10″×12.5″ ultrasonication bath (BLACKSTONE-NEY, PROT-0512H EP ultrasonic bath driven by a 12T MultiSonik™ generator) is filled with about 4″ of water and the dish containing the film is floated in the water and ultrasonicated at 104 KHz for 5 minutes. The film is then removed from the dish and dried 1.5 minutes in an oven at 80° C. At the completion of the drying step, the film has lines of PVP coating that define a negative image of the originally printed positive image. The patterned polyester is next sputter coated with ITO using a CHA Mark 50 roll coater to deposit a 1250 angstroms thick ITO film. The ITO coated patterned polyester is then ultrasonicated for 3 minutes in a beaker containing water placed in a Fisher #FS220H ultrasonicator (Fisher Scientific, Pittsburg, Pa.). The film is then rinsed with de-ionized water and dried by blowing the water off with a stream of air. The resulting film has ITO structures in the shape of the originally printed positive image.

In one embodiment, the process shown in FIGS. 6A-1 through 6F-2 comprises sputter deposition of ITO film on a PET substrate having a hydrophilic coating, e.g., Melnix 582, and printed using warm red ink (Environmental Ink). In one embodiment, this combination of materials allows the ITO to be stripped from undesired areas ultrasonically using a water based stripper.

In one embodiment, the water based stripper for ITO stripping could be a surfactant solution such as JEM-126 (sodium tripolyphosphate, sodium silicate, nonyl phenol ethoxylate, ethylene glycol monbutyl ether and sodium hydroxide), detergent formulation 409, hydroproxide, and developer Shipley 453, etc.

In one embodiment, the ITO stripping rate depends on the solvent concentration, solvent temperature, and the position of the substrate film relative to the ultrasound transducer.

In one embodiment, prior to the ITO sputter deposition, the ink printed PET surface is pre-treated with an appropriate plasma. In one embodiment, such plasma pretreatment minimizes the generation of micro-cracks on the patterned ITO structures during the ITO stripping process. In addition, such plasma pre-treatment may in one embodiment prevent ITO residue from being generated on the printed ink area as a result of removal of part of the printed ink pattern due to high energy plasma, which may generate ITO residue on the printed ink area during the stripping process.

In order to eliminate the optical impact of minor ink residue appearing on the stripped ITO surface, in one embodiment a colorless ink printed on the PET surface is preferred.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. A process for forming a patterned conductive thin film structure on a substrate, comprising:
printing on the substrate a pattern comprised of a printable strippable material, the printed strippable material defining an area on the substrate where the conductive thin film structure is to be formed by comprising a negative image thereof such that the printed strippable material is present in areas on the substrate where the conductive thin film structure is not to be formed and the printed strippable material is substantially not present in the area on the substrate where the conductive thin film structure is to be formed;
depositing a thin film of conductive material on the patterned substrate; and
stripping the strippable material from the substrate;
whereby the strippable material and any conductive material formed thereon are removed by said stripping leaving behind the conductive thin film structure.

2. The process for forming a patterned conductive thin film structure on a substrate as recited in claim 1, wherein the strippable material comprises a strippable ink.

3. The process for forming a patterned conductive thin film structure on a substrate as recited in claim 1, wherein the strippable material comprises a strippable masking coating.

4. The process for forming a patterned conductive thin film structure on a substrate as recited in claim 1, wherein the strippable material is polymer-based.

5. The process for forming a patterned conductive thin film structure on a substrate as recited in claim 1, wherein the strippable material is wax-based.

6. The process for forming a patterned conductive thin film structure on a substrate as recited in claim 1, wherein the strippable material comprises an additive selected from the group consisting of surfactants, fillers, pigments, dyes, curing agents, and plasticizers; whereby the presence of said additive facilitates the stripping of the strippable material subsequent to the deposition of the conductive thin film.

7. The process for forming a patterned conductive thin film structure on a substrate as recited in claim 1, wherein the step of stripping comprises using a solvent to remove the strippable material.

8. The process for forming a patterned conductive thin film structure on a substrate as recited in claim 7, wherein the solvent is selected from the group consisting of water, aqueous solutions, alcohols, ketones, esters, ethers, amides, hydrocarbons, alkylbenzenes, pyrrolidones, sulfones, DMSO, and their mixtures and derivatives.

9. The process for forming a patterned conductive thin film structure on a substrate as recited in claim 1, wherein the conductive material is a material selected from the group consisting of metals, metal oxides, and their alloys and multilayer composites.

10. The process for forming a patterned conductive thin film structure on a substrate as recited in claim 1, wherein the conductive material is a metal selected from the group consisting of aluminum, copper, zinc, tin, molybdenum, nickel, chromium, silver, gold, iron, indium, thallium, titanium, tantalum, tungsten, rhodium, palladium, platinum and cobalt.

11. The process for forming a patterned conductive thin film structure on a substrate as recited in claim 1, wherein the conductive material is a metal oxide selected from the group consisting of indium tin oxide (ITO), indium zinc oxide (IZO), aluminum zinc oxide, gadolinium indium oxide, tin oxide, or fluorine-doped indium oxide.

12. The process for forming a patterned conductive thin film structure on a substrate as recited in claim 1, wherein the step of depositing a thin film of conductive material comprises sputtering.

13. The process for forming a patterned conductive thin film structure on a substrate as recited in claim 1, wherein the step of depositing a thin film of conductive material comprises vapor deposition.

14. The process for forming a patterned conductive thin film structure on a substrate as recited in claim 1, wherein the step of depositing a thin film of conductive material comprises vacuum deposition.

15. The process for forming a patterned conductive thin film structure on a substrate as recited in claim 1, wherein the step of depositing a thin film of conductive material comprises electroplating.

16. The process for forming a patterned conductive thin film structure on a substrate as recited in claim 1, wherein the step of depositing a thin film of conductive material comprises electro-less plating.

17. The process for forming a patterned conductive thin film structure on a substrate as recited in claim 1, wherein the step of depositing a thin film of conductive material comprises electro-forming.

18. The process for forming a patterned conductive thin film structure on a substrate as recited in claim 1, wherein the step of printing comprises flexographic printing.

19. The process for forming a patterned conductive thin film structure on a substrate as recited in claim 1, wherein the step of printing comprises driographic printing.

20. The process for forming a patterned conductive thin film structure on a substrate as recited in claim 1, wherein the step of printing comprises electrophotographic printing.

21. The process for forming a patterned conductive thin film structure on a substrate as recited in claim 1, wherein the step of printing comprises lithographic printing.

22. The process for forming a patterned conductive thin film structure on a substrate as recited in claim 1, wherein the step of printing comprises gravure printing.

23. The process for forming a patterned conductive thin film structure on a substrate as recited in claim 1, wherein the step of printing comprises thermal printing.

24. The process for forming a patterned conductive thin film structure on a substrate as recited in claim 1, wherein the step of printing comprises inkjet printing.

25. The process for forming a patterned conductive thin film structure on a substrate as recited in claim 1, wherein the step of printing comprises screen printing.

26. The process for forming a patterned conductive thin film structure on a substrate as recited in claim 1, wherein the substrate comprises a plastic substrate.

27. The process for forming a patterned conductive thin film structure on a substrate as recited in claim 26, wherein the patterned conductive thin film structure comprises a flexible printed circuit board or a portion of a flexible printed circuit board.

28. The process for forming a patterned conductive thin film structure on a substrate as recited in claim 26, wherein the plastic substrate comprises a portion of a roll of plastic substrate.

29. The process for forming a patterned conductive thin film structure on a substrate as recited in claim 28, wherein the process for forming a patterned conductive thin film structure on a substrate is a component part of a roll-to-roll process for fabricating a display.

30. The process for forming a patterned conductive thin film structure on a substrate as recited in claim 29, wherein the display is an electrophoretic display.

31. The process for forming a patterned conductive thin film structure on a substrate as recited in claim 29, wherein the display is a passive matrix electrophoretic display.

32. The process for forming a patterned conductive thin film structure on a substrate as recited in claim 29, wherein the display is an in-plane switching electrophoretic display.

33. The process for forming a patterned conductive thin film structure on a substrate as recited in claim 29, wherein the display is a dual-mode switching electrophoretic display comprising a plurality of electrophoretic cells filled with charged particles and a colored solvent in which the display is configured such that the particles can be driven between the top and bottom of the electrophoretic cells in a first mode and can be driven horizontally (in-plane) in a second mode.

34. The process for forming a patterned conductive thin film structure on a substrate as recited in claim 1, further comprising laminating the substrate with the conductive thin film structure formed thereon to a display medium layer.

35. The process for forming a patterned conductive thin film structure on a substrate as recited in claim 34, wherein the display medium layer comprises a layer of electrophoretic cells.

36. The process for forming a patterned conductive thin film structure on a substrate as recited in claim 35, wherein said electrophoretic cells are prepared by embossing.

37. The process for forming a patterned conductive thin film structure on a substrate as recited in claim 35, wherein said electrophoretic cells are closed and sealed by a polymeric sealing layer.

38. The process for forming a patterned conductive thin film structure on a substrate as recited in claim 1, wherein the conductive thin film structure comprises an electrode.

39. The process for forming a patterned conductive thin film structure on a substrate as recited in claim 38, wherein the electrode is a segment electrode.

40. The process for forming a patterned conductive thin film structure on a substrate as recited in claim 38, wherein the electrode is a column electrode.

41. The process for forming a patterned conductive thin film structure on a substrate as recited in claim 38, wherein the electrode is a row electrode.

42. The process for forming a patterned conductive thin film structure on a substrate as recited in claim 38, wherein the electrode is a pixel electrode.

43. The process for forming a patterned conductive thin film structure on a substrate as recited in claim 1, wherein the conductive thin film structure comprises a conductive trace.

44. A process for forming a patterned conductive thin film structure on a substrate, comprising:
printing with a printable material on the top surface of the substrate a pattern that defines the area where the conductive thin film structure is to be formed by comprising a positive image thereof such that the printable material is printed in the area where the conductive thin film structure is to be formed;
depositing a conductive thin film layer on the patterned top surface of the substrate, wherein the conductive thin film, the printable material, and the substrate are chosen so that the conductive thin film adheres more strongly to the printable material than to the substrate; and
stripping from the substrate the portions of the conductive thin film formed directly on the substrate using a stripping process that does not strip the conductive thin film from the printable material such that the conductive thin film structure remains formed on the printable material used to define the area in which the conductive thin film structure was to be formed.

45. The process for forming a patterned conductive thin film structure on a substrate as recited in claim 44, wherein the printable material comprises a primer coating, adhesive, or adhesion promoting material.

46. The process for forming a patterned conductive thin film structure on a substrate as recited in claim 44, wherein the printable material comprises ink.

47. The process for forming a patterned conductive thin film structure on a substrate as recited in claim 44, wherein the printable material is radiation curable.

48. The process for forming a patterned conductive thin film structure on a substrate as recited in claim 44, wherein the printable material is thermal curable.

49. A process for forming a patterned conductive thin film structure on a substrate, comprising:
printing with a printable first material on the top surface of the substrate a pattern that defines the area where the conductive thin film structure is to be formed by comprising a positive image thereof such that the printable first material is printed in the area where the conductive thin film structure is to be formed, the printable first material being water repelling and strippable using a solvent other than water;
overcoating the printed top surface of the substrate with a water based second material, such that the second material is repelled by the first material and fills in the areas of the substrate between the areas where the first material has been printed without coating the areas where the first material is present;
stripping the first material away using a process that strips away the first material without stripping away the second material, such that the second material remains coated on the portions of the substrate where the first material was not present, thereby defining the boundaries of the conductive thin film structure by comprising a negative image thereof such that the second material is not present in and the first material has been stripped from the area where the conductive thin film structure is to be formed;
depositing a conductive thin film layer on the patterned top surface of the substrate; and
stripping the second material to form the conductive thin film structure.

50. A process for forming a patterned conductive thin film structure on a substrate, comprising:
printing on a first surface of the substrate a first pattern comprised of strippable material, the first pattern of strippable material defining an area on the first surface of the substrate where a first conductive thin film structure is to be formed;
depositing a thin film of conductive material on the patterned first surface of the substrate;
stripping the first pattern of strippable material from the substrate; printing on a second surface of the substrate a second pattern comprised of strippable material, the second pattern of strippable material defining an area on the second surface of the substrate where a second conductive thin film structure is to be formed;
depositing a thin film of conductive material on the patterned second surface of the substrate; and
stripping the second pattern of strippable material from the substrate; whereby the first pattern of strippable material, the second pattern of strippable material, and any conductive material formed on either the first or the second pattern of strippable material are removed leaving behind the first conductive thin film structure on the first surface of the substrate and the second conductive thin film structure on the second surface of the substrate.

51. A process for forming a patterned conductive thin film structure on a substrate, comprising:
printing on a first surface of the substrate a first pattern comprised of strippable material, the first pattern of strippable material defining an area on the first surface of the substrate where a first conductive thin film structure is to be formed;
printing on a second surface of the substrate a second pattern comprised of strippable material, the second pattern of strippable material defining an area on the second surface of the substrate where a second conductive thin film structure is to be formed;
depositing a thin film of conductive material on the patterned first surface and on the patterned second surface of the substrate; and
stripping the first pattern and second pattern of strippable material from the substrate;
whereby the first pattern of strippable material, the second pattern of strippable material, and any conductive material formed on either the first or the second pattern of strippable material are removed leaving behind the first conductive thin film structure on the first surface of the substrate and the second conductive thin film structure on the second surface of the substrate.

52. The process for forming a patterned conductive thin film structure on a substrate as recited in claim 1, wherein the step of stripping comprises using solvent to remove the strippable material.

53. The process for forming a patterned conductive thin film structure on a substrate as recited in claim 1, wherein the step of stripping comprises using mechanical pressure to remove the strippable material.

54. The process for forming a patterned conductive thin film structure on a substrate as recited in claim 1, wherein using mechanical pressure comprises brushing.

55. The process for forming a patterned conductive thin film structure on a substrate as recited in claim 1, wherein using mechanical pressure comprises using a spray nozzle.

56. The process for forming a patterned conductive thin film structure on a substrate as recited in claim 1, wherein the step of stripping comprises:
applying an adhesive layer having a higher adhesive strength with respect to the metal thin film and/or strippable material than the adhesive strength of the strippable material to the substrate; and
removing the strippable material and any metal thin film formed thereon by peeling off the adhesive layer.

57. The process for forming a patterned conductive thin film structure on a substrate as recited in claim 44, wherein the step of stripping comprises using solvent to remove the strippable material.

58. The process for forming a patterned conductive thin film structure on a substrate as recited in claim 44, wherein the step of stripping comprises using mechanical pressure to remove the strippable material.

59. The process for forming a patterned conductive thin film structure on a substrate as recited in claim 44, wherein using mechanical pressure comprises brushing.

60. The process for forming a patterned conductive thin film structure on a substrate as recited in claim 44, wherein using mechanical pressure comprises using a spray nozzle.

61. The process for forming a patterned conductive thin film structure on a substrate as recited in claim 44, wherein the step of stripping comprises:
applying a second adhesive layer to the substrate after the conductor deposition step; and removing the conductor thin film on the area without the first printed adhesive or adhesion promoting material by peeling off the second adhesive layer.

62. The method of claim 61, wherein the adhesion strength between conductor thin film and the substrate is the weakest as compared to the cohesion strength of the second adhesive layer, the cohesion strength of the first adhesive or adhesion promoting material, the cohesion strength of the metal thin film, the adhesion strength between the metal thin film and the second adhesive layer, and the adhesion between the metal thin film and the first adhesive or adhesion promoting material.

63. The process for forming a patterned conductive thin film structure on a substrate as recited in claim 1, wherein the step of stripping comprises:
applying an adhesive layer to the substrate after the conductor deposition step; and removing the conductor thin film on the area with the first printed adhesive or adhesion promoting material by peeling off the adhesive layer.

64. The method of claim 63, wherein the cohesion strength of the conductor thin film and the adhesion strength between conductor thin film and the substrate are stronger than any of the three forces: the cohesion strength of the strippable material, the adhesion strength between the conductor thin film and the strippable material, and the adhesion strength between the strippable material and the substrate.
